(19) United States
(12) Patent Application Publication
(10) Pub. No.: US 2008/0292418 A1
(43) Pub. Date: Nov. 27, 2008

(54) Novel composite tool holders and boring tools

(76) Inventors: Gregory J. Kay, Midland, MI (US); Richard Theriault, Carlsbad, CA (US); Lawrence Schoenleber, Carlsbad, CA (US)

Correspondence Address: MCKELLAR IP LAW, PLLC, 784 SOUTH POSEYVILLE ROAD, MIDLAND, MI, 48640, US

(21) Appl. No.: 12/070,971

(22) Filed: Feb. 22, 2008

Related U.S. Application Data
(60) Provisional application No. 60/902,996, filed on Feb. 22, 2007.

(51) Int. Cl. B23B 51/00; B32B 15/04; B32B 9/00; B32B 27/34

(52) U.S. Cl. 408/238; 428/457; 428/689; 428/474.4

(57) ABSTRACT

Tool bars that are manufactured as a composite, that is, layered devices. The tool bars can have a solid core, covered with a wrapped composite material, and then optionally covered with a metal sleeve. The tool bars are provided with high strength, improved stiffness over prior art tool bars, high density, low coefficient of thermal expansion, high damping capacity, improved rigidity, improved damping, less chatter and vibration, improved work piece tolerance, improved surface finish, increased speed/fee rates, and low production cost.

This application claims priority from U.S. provisional patent application Ser. No. 60/902,996, filed Feb. 22, 2007.

The invention disclosed and claimed herein deals with tool bars that are manufactured as a composite, that is layered devices, that provide the tool bars with high strength, improved stiffness over prior art tool bars, high density, low coefficient of thermal expansion, high damping capacity, improved rigidity, improved damping, less chatter and vibration, improved work piece tolerance, improved surface finish, increased speed/fee rates, and low production cost.

### BACKGROUND OF THE INVENTION

The tool bars of this invention have heretofore been manufactured from steel or other hardened metal and in at least one tool, composite segments, that is, portions of the tool were manufactured from composites.

Tool bars for use in the mounting of cutting tools, such as conventional boring and reaming bars, are manufactured to be elongated in order to machine deep holes. This configuration leads to low bending strength and low stiffness and thus, a bending phenomenon in the tool is generated. Because of this, the machining accuracy is lowered and chattering is produced on the surface to be machined. This chattering is due to it low natural frequency. Accordingly, upper thresholds of cutting speeds and feed rates are low, and it is impossible to consistently machine accurate deep holes. In order to overcome such disadvantages, various shapes of cutting tools and tool bars for use in mounting the cutting tools have been developed. Many other tool bars for use in the mounting of cutting tools have been manufactured from tungsten carbide alloy and tool steel and they have very excellent stiffness and rigidity characteristics. It is difficult to machine cemented carbides. Further, since frequency of a boring bar or a reaming bar is low due to high densities of tungsten carbide and tool steel, there is a limitation on improvement of the cutting speed of the bar.

One prior art device is that found in U.S. Pat. No. 4,998,851, that issued Mar. 12, 1991 to Hunt, there is described a vibration dampened boring bar that has a longitudinal axis with a steel head section having a cutting insert displaced from the longitudinal axis. A cemented carbide section is joined directly thereto and in one embodiment, an intermediate section includes a devibrator body. This tool does not have a full composite body, in that, only a segment of the bar is a composite material.

One other prior art device known to the inventors can be found in U.S. Pat. No. 6,935,816, issued on Aug. 30, 2005 to Lee, et al in which there is disclosed a tool bar that includes an adaptor constructed to be coupled to a driving device, a body constructed to be mounted with cutting tools and a tip constructed to be supported by a work piece, said body being constructed to be mounted with one or more cutting tools, wherein the adaptor and tip are made of metal material and the body is made of composite material having high stiffness. The body, or composite material, is coated with a nickel cadmium coating.

### THE INVENTION

It is an object of the present invention to provide high stiffness composite bars using high stiffness composite materials. These bars are intended to be substituted for conventional boring and reaming bars discussed Supra, which have been made of tungsten carbide alloy, tool steel, and segments or portions of composites.

The invention comprises in one embodiment, a mandrel stem useful in boring tools, said mandrel stem being manufactured from the group consisting of metal, ceramic, and plastic wherein the mandrel stem is covered with a wrapped composite material.

In another embodiment, this invention comprises the mandrel stem described just Supra, that has an elongated metal sleeve covering the composite material.

Yet another embodiment is a composite tool holder comprising a solid steel rod having a predetermined outside diameter. The solid steel rod has a center segment, a first end segment, and a second end segment. The first end segment is capable of being converted to a tool head, the second end segment is capable of being converted to a tool tail. The center segment has a lesser diameter than the first end segment and the second end segment and said center segment is covered with a cured wrapped composite material.

Going to another embodiment of this invention, there is a mandrel stem comprising a solid steel rod The steel rod has a first end and a second end, wherein the first end is capable of being affixed to a solid steel head and the second end is capable of being affixed to a solid steel tail. The solid steel rod is covered with a cured wrapped composite material.

An additional embodiment is a composite tool holder comprising a solid steel rod having a predetermined outside diameter. The solid steel rod has a center segment, a first end segment, and a second end segment, the first end segment having a butt end, which butt end is smaller in diameter than the outside diameter of the first end segment, the second end segment having a front end, which front end is smaller in diameter than the outside diameter of the second end segment.

The first end segment is capable of being converted to a tool head, the second end segment is capable of being converted to a tool tail. The center segment has a lesser diameter than the butt end of the first end segment and the front end of the second end segment and said center segment. The center segment, the butt end of the first end segment and the front end of the second end segment are covered with a cured wrapped composite material.

The invention, in yet another embodiment that is disclosed and claimed herein is a boring tool comprising a metal boring head coupled to a mandrel stem, said mandrel stem being covered by a wrapped composite material, and in another embodiment, the wrapped composite material is covered by a metal sleeve, and in still another embodiment, the metal sleeve has a long axis, and a portion of the metal sleeve has at least one flat surface along the long axis on the exterior surface.

In one embodiment, the composite tool holders of this invention comprise a solid steel rod that is wrapped with a composite material.

In another embodiment, the metal boring heads and tails are coupled to the mandrel stem and the coupling of the metal boring head and the mandrel stem are achieved by a method selected from the group consisting of: (A) heat shrinking one end of the mandrel stem into a centered opening in the back end of the metal boring head; (B) heat pressing one end of the mandrel stem into a centered opening in the back end of the metal boring head; (C) threading one end of the mandrel stem into a centered opening in the back end of the metal boring head wherein the boring head centered opening has the inner diameter threaded and the outer diameter of one end of the mandrel stem is threaded to accommodate the inner diameter threads; (D) chemical adhesive bonding, and (E) vacuum assisted chemical adhesive bonding.

A wrapped composite material covers the metal mandrel stem, and in another embodiment, a metal sleeve covers the composite material. The metal sleeve has a long axis, and a portion of the metal sleeve can have at least one flat surface along the long axis on the exterior surface.

In another embodiment of this invention there is a method of manufacturing a boring bar. The method comprises providing a solid steel bar having a predetermined thickness and a predetermined length and removing steel from the solid metal bar to provide a metal mandrel stem having a predetermined thickness while leaving a portion of the solid metal bar to provide a boring head.

The boring head is milled to provide desired features into the boring head and then the mandrel stem is covered with a composite material in a predetermined thickness. The composite material can then be covered with a metal sleeve.

There is yet another embodiment of this invention that is a method for manufacturing a boring bar. The method comprises providing a first solid metal bar having a predetermined thickness and a predetermined length as a basis for a boring head, said solid metal bar having a back end, and providing a centered opening in the back end of the first solid metal bar at a predetermined depth.

A second metal bar having a predetermined length and a thickness less than the thickness of the first solid metal bar is provided to provide a metal mandrel stem.

One end of the second metal bar is inserted into the centered opening in the back of the first solid metal bar and the first solid metal bar and second solid metal bar are coupled together.

Then, the first solid metal bar is milled to provide a boring head having desired features.

The coupling of the metal boring head and the mandrel stem is achieved by a method selected from the group consisting of heat shrinking one end of the mandrel stem into a centered opening in the back end of the metal boring head; heat pressing one end of the metal mandrel stem into a centered opening in the back end of the metal boring head; threading one end of the mandrel stem into a centered opening in the back end of the metal boring head wherein the boring head centered opening has the inner diameter threaded and the outer diameter of one end of the mandrel stem is threaded to accommodate the inner diameter threads; chemical adhesive bonding, and vacuum assisted chemical adhesive bonding.

The second solid metal bar is wrapped with a composite material and then, optionally, the wrapped composite material can then be covered with a metal sleeve.

There is still another embodiment of this invention that is a tool bar including a metal adaptor constructed to be coupled to a driving device, a central body, and a metal head wherein the metal adaptor, central body and metal head are coupled together in a linear axis.

The central body is manufactured from a mandrel stem at the center, surmounted by a wrapped composite material. Optionally, a metal sleeve can cover the composite material.

Composite materials of this invention are, for example, those known in the prior art and include carbon fibers in a binder matrix, such as an epoxy resin. As opposed to the prior art devices, the tools of this invention acquire their composite coverings by wrapping the uncured composite materials, for example, carbon fibers in the epoxy resin mentioned just Supra, the then the composite material is cured.

For long fiber composites, that is, those having a length of two inches or greater, the composites are made by filament winding using wet processes or prepregs. Also, the wrapping can be achieved by hand layup, wherein woven clothes or prepregs can be used, such materials including braided materials, or uni-tape prepregs. These materials can be cured in vacuum bags in an oven, or an autoclave. In one embodiment, the composites can be shrink wrapped and shrunk and compacted and then oven cured. Alternately, the composites on the tool holders can be applied using a roll table, similar to hand layup only the material is applied by a machine. Typically, this is the method used for golf shafts and fishing poles. Also, the composites can be made by pultrusion techniques where the uncured long fiber composite is pulled through a die or the like as it cures, all of the above-mentioned techniques being well-known to those skilled in the art.

Any thermoplastic resins or thermoset resins that are heat cured can be used, especially the known vinyl esters, polyesters, and the epoxy resins.

The properties obtained by the methods of this invention provide the composite tool holding devices that have an improvement in damping properties, improvement in cutting stability, improvement in dynamic stiffness, increased speed/rotation, and especially important, a decrease in the weight of the tools.

Advanced fiber reinforced polymer matrix composites can be used to decrease the weight of the tool holders, increase the dampening qualities without decreasing the dynamic stiffness. Carbon fibers provide very high specific stiffness, that is stiffness/density, and the epoxy resins provide very high dampening polymer matrices. The specific stiffness and strength of conventional metals are very low while advanced composite will exhibit both high specific stiffness and strength.

Composite materials have a Static Stiffness value in between steel and tungsten carbide, have a very high dampening factor, a very, very high dynamic stiffness, and the composite materials are light weight. Steel is very hard, but exhibits low modulus under stress.

It should be noted for purposes of this invention that the composites of this invention are wrapped, and can be layered and wrapped, meaning that more than one layer can be used to provide the composite. Although the preferred method for wrapping is to wrap the uncured composite material around the central portions of the tool, it is contemplated within the scope of this invention to provide pre-wrapped uncured compositions that are then used to cover the central portions of the tool and then cured.

The uncured composite materials can be based on heat shrink binders. Such composite materials are wrapped around the central segment of the tool holder and then heated to shrink the composite to be essentially equivalent to the outside dimensions of the steel rod, or the uncured composite materials can be built oversize, wrapped around the central segment of the steel rod, and then compacted or compressed to be essentially equivalent to the outside dimensions of the steel rod.

It should also be noted that contemplated within the scope of this invention are configurations of the steel rods that have tapers that rise from the central portion to the ends of the rod. Also, there is contemplated within the scope of this invention that is provided step down portions from the end segments to the central body of the holders, or combinations of tapers and step downs in one steel rod, all of which will be illustrated infra.

The composites of this invention can be wrapped in various configurations, depending on the amount of dampening and stiffness required in the tool. For example, the composites can be wrapped on the tool in a configuration having an angle of from 0° to 90° from the linear long axis of the tool. The closer the wrap is to 0°, the better the dampening effects of the tool, while higher angles provide more stiffness.

It should be noted that contemplated and shown in this invention are wrappings that can not only cover the central body, but also cover tapers and step downs built into the tools. This preferred method of wrapping provides strength to the tool in and around the junctures of the head to the central body (mandrel stem) and the tail segment to the mandrel stem.

The tools of this invention are heat treated to provide additional hardness to the steel used therein. It is known to use case hardening, that is hardening of from 0.005 to 0.010 inches in depth from the surface of the metal inward into the metal in order to provide hardness to the metal against cuts, dents, and abrasions.

The invention herein, in addition to the case hardening techniques, also provides for heat treating the steel all the way through to provide hardness throughout the steel. Preferred for this invention is heat treating the steel to provide a Rockwell Hardness of from 42 to 55 throughout the entire steel components of this invention.

It should be noted by those skilled in the art that this invention also provides for a tool that has an open bore through the long center of the rod to provide a channel to provide cooling agents to the tool while it is being used. Specifically useful for this purposes to use a tube of steel rather than cut a bore through the center of the long steel rod.

The size of the tools useful herein depends on the end use for the tool. Those skilled in the art know the ratios of diameter of the tool to the length of the tool to provide the properties desired.

### BRIEF DESCRIPTION OF THE DRAWINGS

FIG. 1 is a view in perspective of a finished tool of this invention.

FIG. 2 is a view in perspective of a finished tool of this invention showing a metal sleeve and the flat surface on the metal sleeve.

FIG. 3 is a tool holder that shows the tapered step down from the front end to the mandrel stem and the tapered step down from the tail end to the mandrel stem.

FIG. 4 is a view in perspective of round metal bar from which the boring bar can be manufactured.

FIG. 5 is a view in perspective of a boring head and a mandrel stem.

FIG. 6 is a view in perspective of composite core body.

FIG. 7 is a view in perspective of a stainless steel exterior sleeve for the composite core body.

FIG. 8 is a full back end view of a finished tool bar of this invention.

FIG. 9 is a side view of a portion of a tool bar of this invention with a metal coupler attached to one end which is opposite the boring head.

FIG. 10 is a view in perspective of a boring head showing the back end of the boring head and showing a centered opening.

FIG. 11 is a view in perspective of a mandrel stem for the boring head of FIG. 10 having threads.

FIG. 12 is a view in perspective of the boring head of FIG. 10 and the mandrel stem of FIG. 11 in combination.

FIG. 13 is a full side view of a boring bar without the composite covering to show one configuration of the boring head and back end to the mandrel stem for the placement of the composite material.

FIG. 14 is a full side view of the boring bar of FIG. 13 showing a composite material that has been wrapped onto the mandrel stem before curing the resin of the composite material.

FIG. 15 is a cross sectional view of FIG. 3 through line B-B showing optional internal threaded sections for coupling the front segment and the back segment of the tool.

FIG. 16 is a full side view of another tool of this invention wherein the front is tapered and the back is a squared step down to the mandrel stem.

FIG. 17 is a full side view of another tool of this invention wherein the front is a squared step down and the back is tapered down to the mandrel stem.

### DETAILED DESCRIPTION OF THE INVENTION

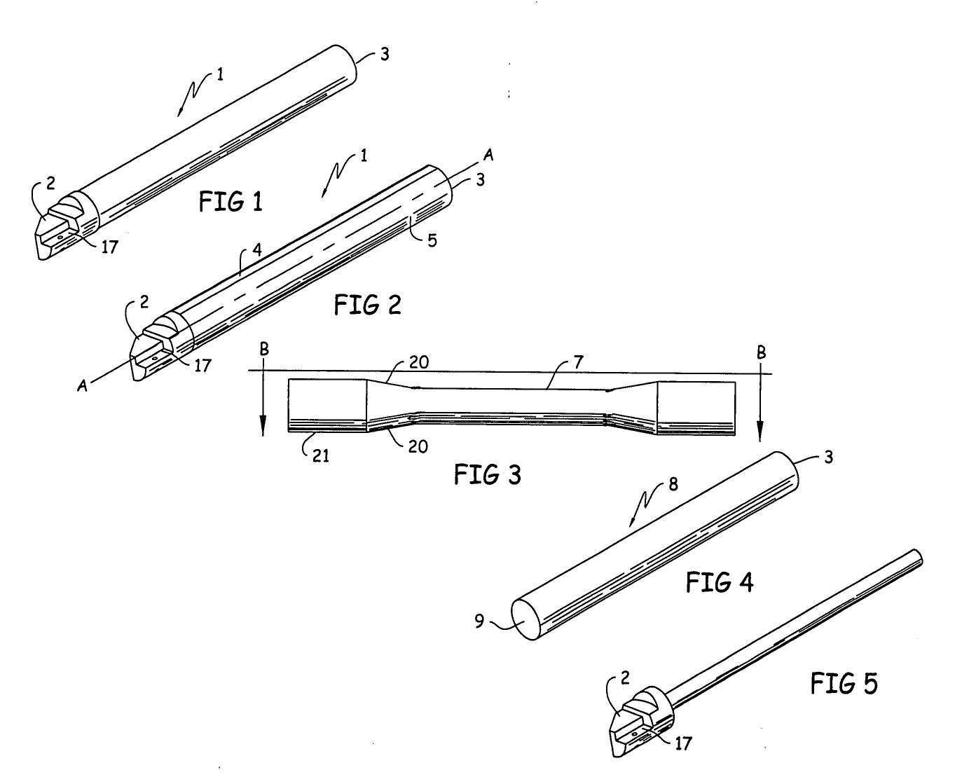

Turning now to FIG. 1 of this invention that is a view in perspective of a finished tool bar 1 of this invention, there is shown the boring head 2, the back end 3, and in FIG. 2, the flat surface 4 along the long axis A-A of the tool bar 1. With reference to FIG. 8, there is shown a full back end 3 view of the finished tool bar 1, showing an exterior steel covering 5, the composite material 6, the mandrel stem 7, and the flat surface 4 along the long axis.

Turning now to FIG. 3, there is shown one embodiment which is a mandrel stem 7 that shows the arcuate step down 20 from the front end 21 to the mandrel stem 7. It is believed by the patentees herein that this arcuate step down 20, as opposed to a sharp angled step down increases the strength of the boring bar by putting less stress on the mandrel stem 7 at this point in the configuration.

Turning now to another embodiment of this invention that is a method of manufacturing the boring tool 1, the method comprises providing a solid metal bar 8 as shown in FIG. 4, said solid metal bar 8 having a front end 9 and a back end 3. The bar has a predetermined thickness based on the desired size of the mandrel stem 7 and the length of the tool bar 1 that is desired.

Metal is removed from the solid metal bar 8 to leave the mandrel stem 7 in the desired thickness and length (See FIGS. 3 and 5) and a certain predetermined amount of the solid metal bar 8 remains intact to provide a basis for the boring head 2 to be manufactured from. The remaining solid metal bar 8 is then milled to provide the desired features in the boring head 2. The boring head 2 is shown in FIGS. 1, 2, and 5 with a cutting tip 17 in place.

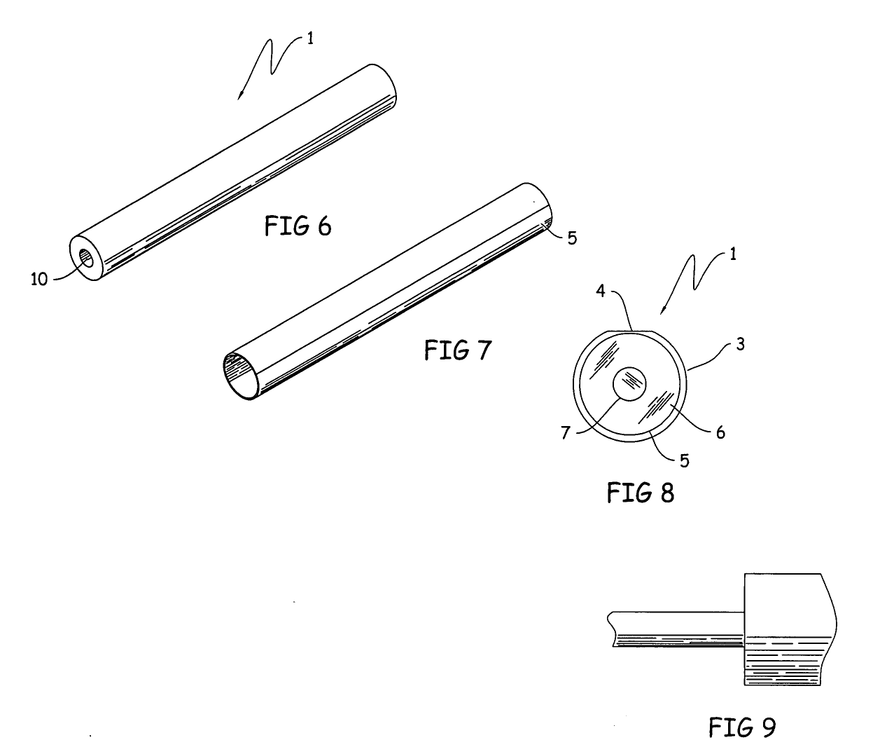

The metal mandrel stem 7 is the covered with the composite material 6, the composite material 6 being shown in FIG. 6. It should be noted that the composite material 6 has a centered opening 10 throughout its entire length to accommodate the metal mandrel stem 7 therein. In another form, the composite material 6 may be formed on the mandrel stem 7 by wrapping an uncured composite precursor material around the mandrel stem 7 and then curing the composite material. For purposes of this invention, conventional composite resins and fillers can be used.

Thereafter, the composite material 6 can be covered with a metal sleeve 5 as is shown in FIG. 5. It should be noted that the metal sleeve 5 can be press fitted onto the composite material 6, or it can be bonded with adhesives to the composite material 6. Preferred for this invention is a stainless steel sleeve, although it is contemplated within the scope of this invention to use other metals.

It should also be noted that the metal sleeve 5 can have at least one flat surface 4 for nearly the entire length of its long axis. This flat surface is to accommodate any clamping tool that may be used to hold the tool bar 1 during use. It is contemplated within the scope of this invention to have more than one flat surface 4 on the surface of the metal sleeve 5.

It is contemplated within the scope of this invention to use adhesives between the mandrel stem 7 and the composite material 6, and it is contemplated within the scope of this invention to use adhesives between the composite material 6 and the metal sleeve 5 in the manufacture of the tool bar 1.

In another embodiment of this invention, there is a method of manufacturing the tool bar 1 of this invention in which there is provided a solid metal bar 11 having a predetermined thickness and a predetermined length, said solid metal bar 11 having a back end 123. There is a centered opening 13 in the back end 12 of the solid metal bar 11, said centered opening 13 having a predetermined depth.

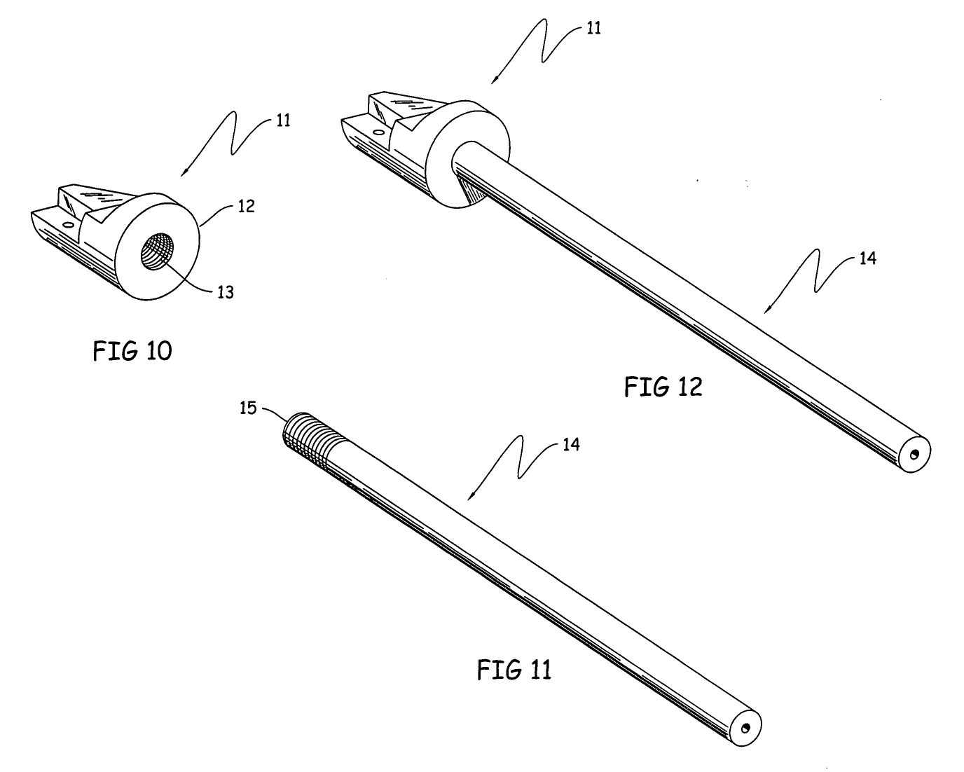

There is provided a second metal bar 14 (FIG. 11), having a predetermined length and a thickness less than the thickness of the first solid metal bar 11 and having a first end 15 (See FIG. 10). The first end 15 is inserted into the centered opening 13 of the solid metal bar 11. The second metal bar 14 and the solid metal bar 11 a coupled together, the manner of which will be discussed infra.

The first metal bar can be milled to obtain the boring head or it can be coupled with the mandrel stem before milling.

The second solid metal bar 14 is then covered with a composite material 6 (FIG. 6) as set forth above for the first method of this invention and then the composite material 6 is covered with a metal sleeve 5 (FIG. 7), both the composite material 6 and the metal sleeve 5 having the properties and capabilities as set forth Supra.

This method of manufacture can also be carried out using adhesives as set forth Supra. Such adhesives are standard and well-known to those skilled in the art.

This invention also contemplates another embodiment, and that is a tool bar that includes a metal adaptor 16 (See FIG. 9) constructed to be coupled to a driving device.

Thus, in its simplest form, the tool bar disclosed and set forth above can be constructed with a metal adaptor 16 that is employed on the back end 3 of the tool bar 1 to provide a drive means for the tool bar 1 (See FIG. 7). Such a metal adaptor 15 can be machined out of a solid metal bar while the tool bar is being manufactured, or can be a separate component that is screwed into the back end 3 of the tool bar 1, or it can be coupled to the tool bar 1 using adhesives.

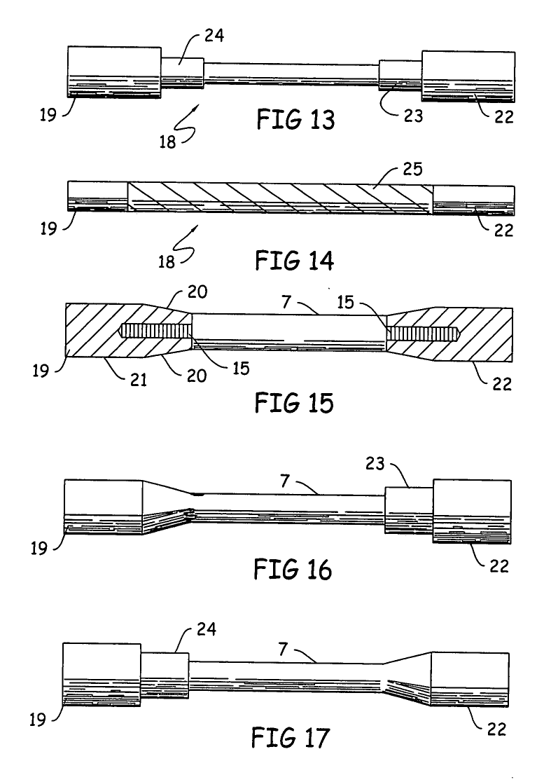

There is shown in FIG. 13, a mandrel stem 18 with a front portion 19 that can be formed into a boring head and a back portion 22 that can be formed into an adaptor if desired. It should be noted that each of the back portion 22 and the front portion 19 has an adaptor 23 and 24, respectively, that can be over wrapped with the uncured composite material 25 (FIG. 14) to help tie together the cured composite material with each of the back portion 22 and the front portion 19 when the uncured composite material 25 is cured.

FIG. 14 shows one such finished mandrel stem 18 after it has been wrapped with the uncured composite material 25.

FIG. 15 shows a cross sectional view of the tool of FIG. 3, with the use of threads 15 to provide the coupling between the first segment 19 and the second segment 22 and the mandrel stem 7.

FIG. 16 shows another embodiment of this invention in which a combination of a square step down 23 from the tail 22 of the tool 1 to the mandrel stem 7.

FIG. 17 shows another embodiment of this invention in which a combination of a square step down 24 from the front end 21 and a taper from the tail end 22 to the mandrel stem 7.

It is contemplated within the scope of this invention to provide mandrel stems by machining as described Supra, or such mandrel stems can be cast. Mandrel stems can be manufactured from metals as described Supra, or they can be cast from ceramics, or formed from high density plastics such as high density polyethylene and high density polypropylene, polyamides, and especially high density cross-linked polyethylene with or without fillers.

It is also contemplated within the scope of this invention to provide mandrel stems that are totally composites, that is, without any metal, ceramic, or plastic center portions.

What is claimed is:

1. A mandrel stem useful in boring tools, said mandrel stem being manufactured from the group consisting of:
a. metal,
b. ceramic, and
c. plastic,
wherein the mandrel stem is covered with a wrapped composite material.

2. A mandrel stem as claimed in claim 1 wherein the mandrel stem is manufactured from metal.

3. A mandrel stem as claimed in claim 2 wherein the metal is steel.

4. A mandrel stem as claimed in claim 1 wherein the mandrel stem is ceramic.

5. A mandrel stem as claimed in claim 1 wherein the mandrel stem is thermoset plastic resin.

6. A mandrel stem as claimed in claim 5 wherein the thermoset plastic resin is polyamide.

7. A composite tool holder comprising:
a solid steel rod having a predetermined outside diameter, said solid steel rod having a center segment, a first end segment, and a second end segment, the first end segment being capable of being converted to a tool head, the second end segment being capable of being converted to a tool tail, said center segment having a lesser diameter than the first end segment and the second end segment and said center segment being covered with a cured wrapped composite material.

8. A composite tool holder as claimed in claim 7 wherein there is an open center bore for conveying a cooling liquid through the solid steel rod.

9. A mandrel stem comprising a solid steel rod, said steel rod having a first end and a second end, wherein the first end is capable of being affixed to a solid steel head and the second end is capable of being affixed to a solid steel tail, wherein the solid steel rod is covered with a cured wrapped composite material.

10. The composite tool holder as claimed in claim 7 wherein there is a portion of the first end segment that is tapered down from the predetermined outside diameter to the diameter of the center segment of the solid steel rod and a portion of the second end segment that is tapered down from the predetermined outside diameter of the solid steel rod to the diameter of the center segment of the solid steel rod and the center segment of the solid steel rod, the tapered down portion of the first end segment and the tapered down portion of the second end segment are covered with a cured wrapped composite material.

11. The composite tool holder as claimed in claim 67 wherein there is a portion of the first end segment that is tapered down from the predetermined outside diameter to the diameter of the center segment of the solid steel rod and a portion of the second end segment is not tapered down from the predetermined outside diameter of the solid steel rod to the diameter of the center segment of the solid steel rod and the center segment of the solid steel rod and the tapered down portion of the first end segment are covered with a cured wrapped composite material.

12. The composite tool holder as claimed in claim 7 wherein a portion of the first end segment is not tapered down from the predetermined outside diameter of the steel rod to the diameter of the center segment of the solid steel rod and a portion of the second end segment is tapered down from the predetermined outside diameter of the solid steel rod to the diameter of the center segment of the solid steel rod and the center segment of the solid steel rod, the tapered down portion of the second end segment are covered with a cured wrapped composite material.

13. A composite tool holder comprising in combination,
(i) the mandrel stem as claimed in claim 9;
(ii) a solid steel head affixed to the first end of (i), and
(iii) a solid steel tail affixed to the second end of (i).

14. A composite tool holder as claimed in claim 13 wherein the mandrel stem, the solid steel head and the solid steel tail are affixed using an adhesive material.

15. A composite tool holder as claimed in claim 13 wherein the mandrel stem is threaded on the first end and the second end, the solid steel head and the solid steel tail are each threaded to fit the threads on the mandrel stem and the mandrel stem, the solid steel head and the solid steel tail are affixed using the threads.

16. A composite tool holder as claimed in claim 13 wherein the solid steel head and the solid steel tail each have a back surface containing a threaded opening to fit the threads on the mandrel stem and, the mandrel stem, the solid steel head and the solid steel tail are affixed using the threads.

17. A composite tool holder as claimed in claim 13 wherein the solid steel head and the solid steel tail each have a back surface containing an opening and the mandrel stem, the solid steel head and the solid steel tail are each affixed by compression fitting one end of the mandrel stem, respectively, into each of the openings in the back surface of the solid steel head and the solid steel tail.

18. The composite tool holder comprising:
a solid steel rod having a predetermined outside diameter, said solid steel rod having a center segment, a first end segment, and a second end segment, the first end segment having a butt end, which butt end is smaller in diameter than the outside diameter of the first end segment, the second end segment having a front end, which front end is smaller in diameter than the outside diameter of the second end segment,
the first end segment being capable of being converted to a tool head, the second end segment being capable of being converted to a tool tail, said center segment having a lesser diameter than the butt end of the first end segment and the front end of the second end segment and said center segment, the center segment, the butt end of the first end segment and the front end of the second end segment being covered with a cured wrapped composite material.

19. A composite tool holder as claimed in claim 7 wherein the cured wrapped material is wrapped at an angle, relative to the long axis of the tool holder, of from 0° to 90°.

20. A composite tool holder as claimed in claim 9 wherein the cured wrapped material is wrapped at an angle, relative to the long axis of the tool holder, of from 0° to 90°.

21. A composite tool holder as claimed in claim 18 wherein the cured wrapped material is wrapped at an angle, relative to the long axis of the tool holder, of from 0° to 90°.

22. A composite tool holder as claimed in claim 7 wherein the composite consists of at least two layers, and each layer is wrapped at the same angle.

23. A composite tool holder as claimed in claim 9 wherein the composite consists of at least two layers, and each layer is wrapped at the same angle.

24. A composite tool holder as claimed in claim 18 wherein the composite consists of at least two layers, and each layer is wrapped at the same angle.

25. A composite tool holder as claimed in claim 7 wherein the composite consists of at least two layers, and each layer is wrapped at a different angle relative to each other.

26. A composite tool holder as claimed in claim 9 wherein the composite consists of at least two layers, and each layer is wrapped at a different angle relative to each other.

27. A composite tool holder as claimed in claim 18 wherein the composite consists of at least two layers, and each layer is wrapped at a different angle relative to each other.

28. The composite tool holder as claimed in claim 7 wherein the steel in the tool is case hardened by heat treatment.

29. The composite tool holder as claimed in claim 9 wherein the steel in the tool is case hardened by heat treatment.

30. The composite tool holder as claimed in claim 18 wherein the steel in the tool is case hardened by heat treatment.

31. The composite tool holder as claimed in claim 7 wherein the steel in the tool holder is heat treated all the way through to provide a Rockwell Hardness of from 42 to 55.

32. The composite tool holder as claimed in claim 9 wherein the steel in the tool holder is heat treated all the way through to provide a Rockwell Hardness of from 42 to 55.

33. The composite tool holder as claimed in claim 18 wherein the steel in the tool holder is heat treated all the way through to provide a Rockwell Hardness of from 42 to 55.

34. A composite tool holder as claimed in claim 7 wherein the wrapped composite material is covered by a metal sleeve.

35. A composite tool holder as claimed in claim 9 wherein the wrapped composite material is covered by a metal sleeve.

36. A composite tool holder as claimed in claim 18 wherein the wrapped composite material is covered by a metal sleeve.

37. A composite tool holder as claimed in claim 7 wherein the layered composite material is covered by a metal sleeve, said metal sleeve having a long axis, and a portion of the metal sleeve having at least one flat surface along the long axis.

38. A composite tool holder as claimed in claim 9 wherein the layered composite material is covered by a metal sleeve, said metal sleeve having a long axis, and a portion of the metal sleeve having at least one flat surface along the long axis.

39. A composite tool holder as claimed in claim 18 wherein the layered composite material is covered by a metal sleeve, said metal sleeve having a long axis, and a portion of the metal sleeve having at least one flat surface along the long axis.

40. A composite tool holder as claimed in claim 7 wherein the composite material is adhered to the metal mandrel stem.

41. A composite tool holder as claimed in claim 9 wherein the metal sleeve is adhered to the composite material.

42. A composite tool holder as claimed in claim 18 wherein the composite material is adhered to the mandrel stem and the metal sleeve is adhered to the composite material.

43. A method of manufacturing a boring bar, said method comprising
A. providing a solid steel bar having a predetermined thickness and a predetermined length;
B. removing metal from the solid metal bar to provide a metal mandrel stem having a predetermined thickness while leaving a portion of the solid metal bar to provide a boring head;
C. milling the boring head to provide desired features into the boring head;
D. wrapping the metal mandrel stem with an uncured composite material precursor in a predetermined thickness and thereafter curing the uncured composite material.

44. The method as claimed in claim 43 wherein the composite material is additionally covered with a metal sleeve.

45. A method for manufacturing a composite tool holder, said method comprising:
A. providing a first solid steel rod having a predetermined thickness and a predetermined length as a basis for a boring head, said solid steel rod having a back end;
B. providing a centered opening in the back end of the first solid steel rod at a predetermined depth;
C. providing a second rod having a predetermined length and a thickness less than the thickness of the first solid steel rod to provide a mandrel stem;
D. inserting one end of the second steel rod into the centered opening in the back of the first solid steel rod and coupling the first solid steel rod and second solid steel rod together,
E. milling the first solid steel rod to provide a boring head having desired features, said coupling of the steel boring head and the mandrel stem being achieved by a method selected from the group consisting of:
(a) heat shrinking one end of the mandrel stem into a centered opening in the back end of the boring head;
(b) heat pressing one end of the mandrel stem into a centered opening in the back end of the steel boring head;
(c) threading one end of the mandrel stem into a centered opening in the back end of the steel boring head wherein the boring head centered opening has the inner diameter threaded and the outer diameter of one end of the mandrel stem is threaded to accommodate the inner diameter threads;
(d) chemical adhesive bonding, and
(e) vacuum assisted chemical adhesive bonding;
(f) wrapping the second solid steel rod with a composite material.

46. The method as claimed in claim 45 wherein additionally, the composite material is covered with a metal sleeve.

47. The method as claimed in claim 45 where, in addition, adhesive is applied to the mandrel stem before the composite material is applied.

48. The method as claimed in claim 47 where, in addition, adhesive is applied to the composite material before the metal sleeve is applied.

49. The method as claimed in claim 47 where, in addition, adhesive is applied to the metal mandrel stem before the composite material is applied and adhesive is applied to the composite material before the metal sleeve is applied.

50. A tool bar including:
(A) a steel adaptor constructed to be coupled to a driving device;
(B) a central body, and
(C) a steel head;
the metal adaptor, central body and metal head being coupled together in a linear axis;
the central body being manufactured from a mandrel stem at the center, surmounted by a wrapped composite material.

51. The tool bar of claim 50 wherein additionally, the composite material is covered by a metal sleeve.

52. A tool bar as claimed in claim 50, wherein the central body is perforated with holes for use in mounting cutting tools in a direction intersecting a longitudinal axis of the central body.
